(19) United States
(12) Patent Application Publication
(10) Pub. No.: US 2005/0045077 A1
(43) Pub. Date: Mar. 3, 2005

(54) Motorized lift device

(76) Inventor: Wieslaw Bober, New York, NY (US)

Correspondence Address: STEINBERG & RASKIN, P.C., 1140 AVENUE OF THE AMERICAS, 15th FLOOR, NEW YORK, NY, 10036-5803, US

(21) Appl. No.: 10/916,953

(22) Filed: Aug. 12, 2004

Related U.S. Application Data
(63) Continuation-in-part of application No. 10/361,421, filed on Feb. 10, 2003.

(51) Int. Cl. A47B 9/00; E02F 3/00; B66F 9/00; B66C 23/00

(52) U.S. Cl. 108/147

(57) ABSTRACT

A motorized lift device facilitating the uninterrupted and nearly noiseless movement of a low-profile television. The motorized lift comprises a base unit having a support unit slidably disposed thereon in a vertically-oriented and telescoping fashion. Support unit movement is controlled via a motor directly coupled to a transmission which is coupled to a screw. Coupling between screw and an elevator plate converts screw rotation to linear motion within the support unit. A low-friction floating nut between elevator plate and screw, as well as several low-friction couplings between base unit and support unit reduce noise, wobbling, eliminate binding, and accommodates for misalignments during movement. The support unit accommodates for vertical and horizontal adjustability during mounting and installation of any size low-profile television.

### CROSS REFERENCE TO RELATED APPLICATIONS

This patent application is a continuation-in-part of U.S. patent application Ser. No. 10/361,421, filed on Feb. 10, 2003, and abandoned on Aug. 12, 2004.

### BACKGROUND OF THE INVENTION

1. Field of the Invention

The present invention generally relates to a motorized lift. Specifically, the invention is a vertically disposed lift facilitating the uninterrupted and nearly noiseless movement of plasma screen and other low-profile televisions.

2. Description of the Related Art

Television design trends are focused on low-profile devices including but not limited to plasma screens and LCD panels. Low-profile televisions maximize viewing area and minimize unit depth. However, designs are inherently less decorative, less stable, and heavier than tube-based televisions.

Aesthetic and stability deficiencies of low-profile televisions are addressed by housing the television within a cabinet. In such applications, the low-profile television is extended from and retracted into the cabinet via a lift.

While lifts are known within the art, vertical motion is typically achieved by indirectly coupling a motor to a platform. Several examples are noteworthy. Park, U.S. Pat. No. 5,797,666, describes a motor attached to a screw and thereafter to a pantographic link work to move a platform. Saper, U.S. Pat. No. 5,273,352, describes a motor attached to a capstan thereby controlling several cables so as to move a platform. Gonnet, U.S. Pat. No. 5,242,217, describes a motor driving several screws via a belt contacting a pulley attached to each screw so as to raise and lower a platform. Roberts, U.S. Pat. No. 4,717,212, describes a motor attached to a sprocket and thereafter communicating with indentations along a column so as to move a platform with sewing machine. Watt, U.S. Pat. No. 4,568,132, Wache et al., U.S. Pat. No. 4,151,804, and Harris, U.S. Pat. No. 2,854,308, describe a motor communicating with a drive screw via a belt-pulley arrangement so as to move a platform. Mattia, U.S. Pat. No. 4,065,194, describes a motor communicating with a screw via a right angle gear box so as to move a platform having a pulpit thereon. Heidorn et al., U.S. Pat. No. 3,982,801, describes a vertically adjustable shelf via a worm and wheel gear arrangement. Cory, U.S. Pat. No. 3,761,152 and Riley, U.S. Pat. No. 2,875,012, describe a motor communicating with several pulleys via a cable so as to move a platform. Gipple, U.S. Pat. No. 2,687,934, describes a motor communicating with a pulley-belt arrangement, worm gear, and wheel gear to vertically move a tray.

Pulleys, belts, cables, and gears as described in the related arts are subject to binding and vibrations, therefore movement is both imprecise and noisy. When applied to the raising and lowering of a low-profile television, the related arts lack the quality of movement required to achieve uninterrupted and nearly noiseless function. Movement quality is further compromised as television weight increases.

There are other problems associated with lifts presently known within the arts. For example, a lift does not exist which has the capability to attach all sizes of low-profile televisions. The lift designs make it difficult to install a low-profile television and are dangerous if fingers are caught in a platform. Slight misalignments of the lift result in noisy operation or failure. Furthermore, a simple inexpensive mechanism is needed for opening and closing a lid of a cabinet which is normally closed and covers the lift mechanism when in the retracted position.

What is currently required is a vertical lift device which allows for easy installation and is capable of raising and lowering a low-profile television in a smooth, stable, and nearly noiseless fashion.

### SUMMARY OF THE INVENTION

An object of the present invention is to provide a robust vertical lift device capable of raising and lowering a low-profile television without binding between moving components.

A further object of the present invention is to provide a robust vertical lift device capable of raising and lowering a low-profile television in a nearly noiseless fashion.

Another object of the present invention is to provide a vertical lift device having vertically and horizontally adjustable supports and a horizontally adjustable shelf for the low-profile television.

A yet further object of the present invention is to provide a vertical lift device which is designed to gradually raise a lid of a cabinet housing the vertical lift as the lift extends to raise the low-profile television from the cabinet.

Another object of the present invention is to provide a vertical lift device having a safety mechanism for preventing a user from be harmed during use.

A further object of the present invention is to provide a vertical lift device that accommodates for lateral movement and misalignment during operation of the lift and eliminates load on the motor.

In one embodiment, the present invention is composed of a support unit slidably disposed along a base unit. The base unit is comprised of a first pair of separately disposed and parallel rails, a second pair of separately disposed and parallel rails, a base plate, an end plate and a stiffener. The base plate is fixed to the rail pairs in a perpendicular fashion adjacent to the lower end of the base unit. The end plate is fixed to the rail pairs in a perpendicular fashion at the upper end of the base unit. The stiffener is fixed to and between the rail pairs so as to minimize flexure within base unit during operation.

The support unit is comprised of a pair of separately disposed and parallel vertical support elements, a pair of separately disposed and parallel horizontal support elements, and a pair of horizontal rests. Horizontal support elements are attached to the vertical support elements allowing adjustment to the distance between the horizontal supports. A horizontal rest is fastened in a perpendicular fashion to each vertical support element at the lower end of the support unit. A portion of the weight of a low-profile television is borne by the horizontal rests. A T-shaped guide is fastened to each vertical support element below the horizontal rest and positioned between a rail pair thereby slidably disposed in a preferred direction. T-shaped guides prevent contact between vertical support elements and rails during operation.

Movement of the support unit is controlled via a motor directly coupled to a drive screw. The drive screw is thereafter coupled to the support unit via an elevator element which converts screw rotation to linear motion.

The elevator element is comprised of an elevator plate, a nut, and a pair of T-shaped guides. The nut is centrally located along the horizontal plane of the elevator plate through its thickness and fastened thereto. A pair of T-shaped guides are oppositely disposed at either end of the elevator plate and fastened thereto so as to secure the elevator element to the rail pairs. Guides prevent contact between rails and vertical support elements.

A reversible motor fastened to the base unit is directly coupled to the drive screw. The drive screw passes through the nut having a complimentary thread arrangement. The drive screw is secured to the end plate so as to allow rotational motion about its lengthwise axis.

A limit switch fastened to the base plate constrains travel of the elevator element between end and base plates. The limit switch is electrically connected to the reversible motor so as to start, stop, and reverse direction of the motor. The limit switch has a rod extending up through the base plate to the end plate and parallel to the screw. A stop is fastened to the rod adjacent to the base plate and the end plate. The elevator plate contacts the stop thereby terminating power to the motor and reversing motor direction when reactivated.

In a second embodiment, the base unit is comprised of the same features as described above. The base unit includes a first pair of separately disposed and parallel rails, a second pair of separately disposed and parallel rails, a base plate, an end plate and a stiffener. The base plate is fixed to the rail pairs in a perpendicular fashion adjacent to the lower end of the base unit. The end plate is fixed to the rail pairs in a perpendicular fashion at the upper end of the base unit. The stiffener is fixed to and between the rail pairs so as to minimize flexure within base unit during operation.

A support unit is comprised of a pair of separately disposed and parallel vertical support elements having attached to each of them a vertical tubular channel which are separately disposed and parallel. A supporting structural member is welded to the vertical support elements and encloses the frontmost rails. A pair of guides which are T-shaped and fastened to each of the vertical support elements are for engagement of the support unit to the base unit and are positioned to partially occupy a space between each pair of rails of the base unit.

The support unit includes a support arm which is attached to one of the vertical tubular channels for engaging and raising a lid of a cabinet when the television is being lifted from the cabinet and for controllably supporting the lid as it closes by gravity as the low-profile display is lowered into the cabinet. The support arm prevents the lid from abruptly falling down during the closing process. The support arm includes a vertical portion attached to an inverted U-shaped portion and is preferably made of a smooth friction resistant material.

A pair of separately disposed and parallel adjustable horizontal support elements are fastened to the vertical tubular channels for mounting the low-profile display and a horizontal shelf is fastened to the tubular channels of the support unit, and provided for temporary support of the low-profile display during installation. The adjustable horizontal support elements are slidably disposed in the vertical tubular channels via fastener assemblies so as to facilitate sliding vertical movement along the channels. The engagement of the vertical tubular channels and the horizontal support elements allow for vertical sliding movement toward or away from each other depending upon the size and positioning of the fastener assemblies. The horizontal support elements may have a plurality of mounting holes provided along their length for fastening different size low-profile displays to the horizontal support elements.

The horizontal shelf comprises a top platform parallel to a bottom platform which is loosely mounted, in a hanging manner, to the top platform via a plurality of connectors. The horizontal shelf is slidably disposed in the vertical tubular channels of the support unit via fastener assemblies. The adjustable engagement of the vertical tubular channels and the horizontal shelf allows the horizontal shelf to be moved up or down to temporarily support the low-profile display in a convenient position while the low-profile display is being installed. Once the installation is complete, the horizontal shelf is moved up so that the shelf is located directly under and supporting the display.

The horizontal shelf includes a safety mechanism comprising a plurality of micro-switches for communicating a stop command to a reversible motor. The plurality of micro-switches are mounted to the top platform and do not touch the bottom platform in the mounted position. During motion of the horizontal shelf, if the bottom platform contacts anything, such as a finger, the bottom platform is compressed up towards the top platform and presses the micro-switches which breaks an electrical circuit and sends an electrical STOP command to the transformer to terminate power to the motor.

A hanging drive screw assembly is parallel and equidistant from the rails. The hanging drive screw assembly comprises a drive screw having a threaded rod of linear extent fabricated from metal, preferably steel, and a ball bearing mechanism. The drive screw assembly passes through an opening in the end plate and is freely movable while it is suspended from the end plate. The mobility of the drive screw accommodates slight misalignment during operation of the motorized lift.

To prevent direct contact between the drive screw and the motor, in this embodiment, the motor is not directly coupled to the drive screw. Rather, the motor is coupled to a transmission which is coupled to the threaded rod of the drive screw. The transmission is located below a floating nut assembly through which the drive screw passes. The drive screw is thereafter coupled to the support unit via an elevator plate which converts screw rotation to linear motion.

The floating nut assembly comprises a floating nut movably mounted in a housing of the elevator plate, and a pair of guides which are T-shaped. The guides are slidably disposed between the rails and prevent direct contact between the support unit and the base unit. The floating nut has an internally threaded opening through its thickness. The drive screw is threaded through the floating nut which moves the elevator plate when the drive screw is rotated. The floating nut has the ability to move around in all directions in the housing and “float” when the drive screw is moving through the elevator plate.

The second embodiment includes a power supply box enclosing the motor, the transformer, a microprocessor and an outlet for a power cord for the motorized lift. The power supply box is positioned underneath the base plate.

The embodiments of the present invention have nuts and T-shaped guides composed of a low-friction polymer. Vibrations inherent to the reversible motor and its function are isolated from the base plate by vibration damping washers.

Several advantages are offered by the present invention. The invention eliminates intermittent binding between base and support units by minimizing the distance between the center of mass of the television and contact points between the units. The invention minimizes chatter in the drive mechanism by directly coupling a reversible motor to a drive screw. The invention minimizes chatter between base and support units by maximizing sliding contact between base and support units.

In the second embodiment, the invention minimizes chatter and the possibility of binding by providing a hanging drive screw which is floatingly mounted to accommodate some degree of misalignment. The horizontal support arms provide a universal mounting mechanism for low-profile display televisions of different sizes. The invention enables gradual control of a lid which covers the lift mechanism in its retracted state and a safety mechanism for reliably stopping the operation of the lift as it descends should an obstruction, such as a finger, be detected. Moreover, the invention provides an adjustable horizontal shelf for the low-profile television for use during installation.

### BRIEF DESCRIPTION OF THE DRAWINGS

The motorized lift will now be described in more detail, by way of example only, with reference to the accompanying drawings, in which:

FIG. 1 is a perspective view of a first embodiment of the present invention showing a support unit retracted.

FIG. 2 is a perspective view of the first embodiment of the present invention showing the support unit extended.

FIG. 3 is an elevation view of the rear of the present invention showing a screw, motor, limit switch, and elevator element.

FIG. 4 is an enlarged view showing the motor attached to a base plate and directly coupled to the drive screw.

FIG. 5 is a section view taken along line 5-5 of FIG. 4 of the elevator element showing the coupling of the elevator plate to rails via T-shaped guides.

FIG. 6 is a section view taken along line 6-6 of FIG. 5 showing the drive screw coupled to the elevator element via a nut.

FIG. 7 is a partial section view of an end plate showing the attachment of the screw and a limit switch rod thereto.

FIG. 8 is a section view taken along line 8-8 of FIG. 3 showing the attachment of a horizontal support element to a vertical support element.

FIG. 9 is a section view taken along line 9-9 of FIG. 3 showing the T-shaped guide slidably disposed between rails and fastened to vertical support elements.

FIG. 10 is a block diagram of a motion control circuit for use in an exemplary embodiment.

FIG. 11 is a perspective view of a second embodiment of the present invention showing the support unit in an extended state.

FIG. 12 is a rear view of the second embodiment showing a drive screw, a motor, a limit switch, and an elevator plate.

FIG. 13 is a perspective view of a second embodiment of the present invention showing the support unit in a retracted position.

FIG. 14 is a top view of the second embodiment showing vertical support elements, vertical tubular channels, rails and an end plate.

FIG. 15 is a perspective view of a cobra arm constituting a component of the second embodiment shown attached to the tubular channel.

FIG. 16 is a front view of the cobra arm constituting a component of the second embodiment shown supporting a lid of a cabinet.

FIG. 17 is a perspective view of a horizontal shelf constituting a component of the second embodiment.

FIG. 18 is a section view taken along line 18-18 of FIG. 17 of the horizontal shelf.

FIG. 19 is a schematic view of an electrical safety circuit situated in the horizontal shelf of the second embodiment of the present invention.

FIGS. 20a and 20b are side views of the second embodiment of the present invention showing the lift with the horizontal shelf in an operating position and in a rotated position, respectively.

FIG. 21 is a front view of the second embodiment of the present invention showing the horizontal shelf moved down during during installation of a low-profile display.

FIG. 22 is a front view of the second embodiment of the present invention showing the horizontal shelf moved up after installation is completed.

FIG. 23 is a perspective view showing an opening between the horizontal shelf and a cabinet.

FIG. 24 is a section view of the second embodiment of the present invention showing a hanging screw assembly mounted in a floating nut assembly, and coupled to a transmission and the motor.

FIG. 25 is an enlarged back view of the second embodiment of the present invention showing the base plate, the motor, the transmission, and the floating nut assembly.

FIG. 26 is a top view of the second embodiment showing vertical support elements, vertical tubular channels, rails and the elevator plate.

FIG. 27 is a block diagram of a power supply box constituting a component of the second embodiment of the present invention.

### DESCRIPTION OF THE INVENTION

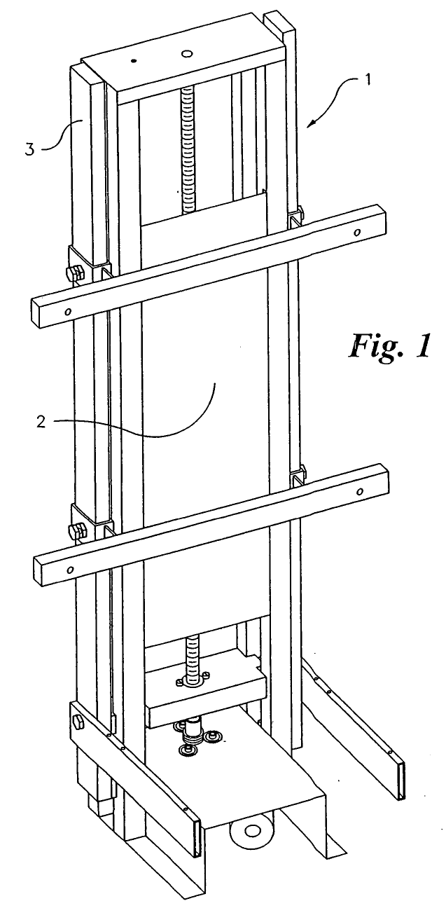

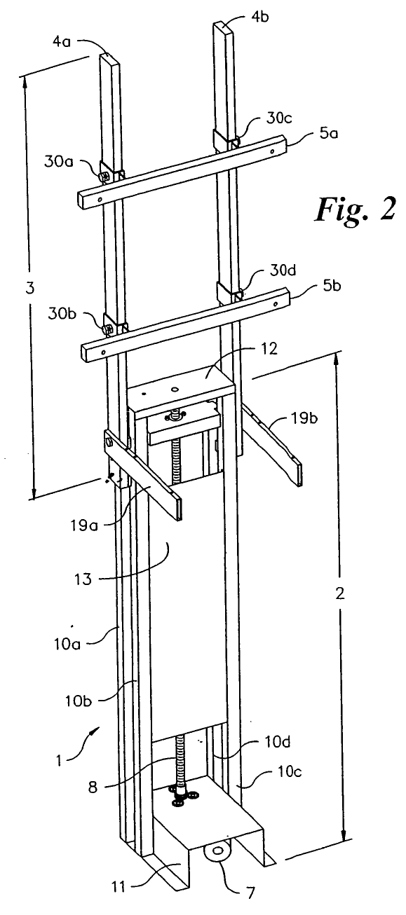

Referring to FIG. 1, an exemplary embodiment of the present invention, namely a lift 1 for vertically positioning a low-profile display, is shown in its retracted state wherein a support unit 3 is telescoped about a base unit 2. FIG. 2 shows the lift 1 having the support unit 3 extended above the base unit 2.

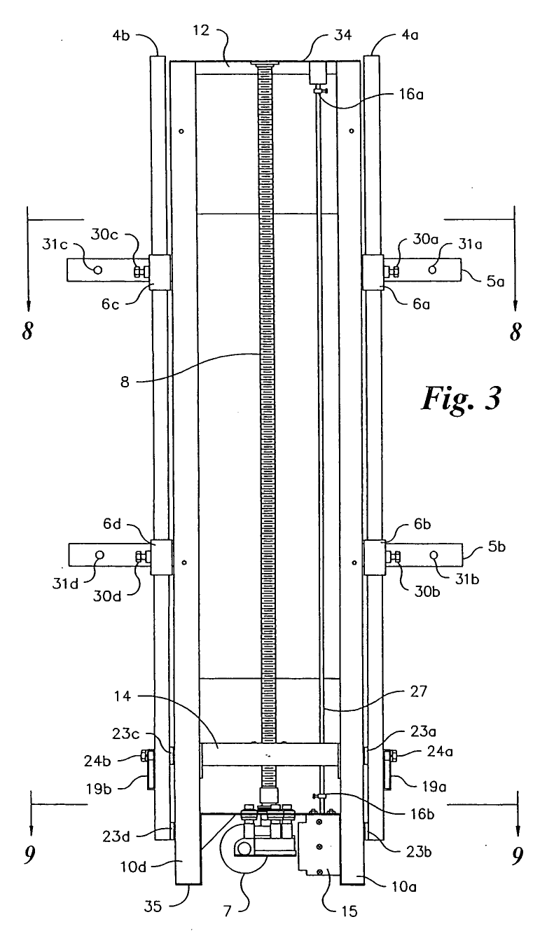

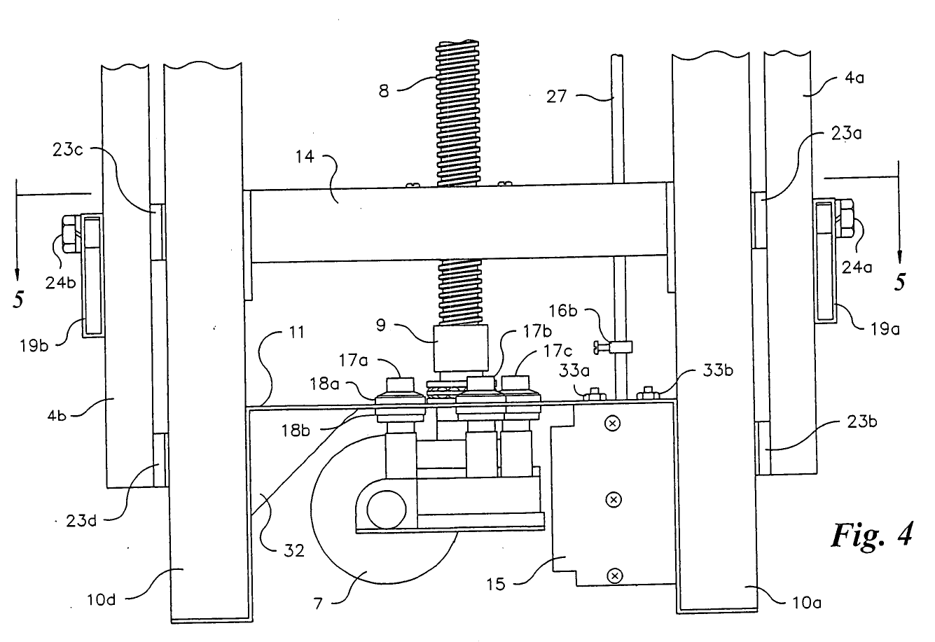

Referring again to FIG. 2, the base unit 2 is comprised of a base plate 11, four rails 10a-10d, an end plate 12, and a stiffener 13. The base plate 11 is a U-shaped element fabricated from sheet metal, preferably steel. Rails 1Oa-1Od are either solid or hollow in construction, preferably having a square or rectangular cross section. Rails 10a-10d are arranged in pairs, 10a-10b and 10c-10d, to either side of the U-shaped base plate 11 so that one end of each rail 10a-10d contacts the base plate 11 adjacent to the lower end 35, as shown in FIG. 3. Rails 10a-10d are welded or fastened to the base plate 11, via techniques understood in the art, so as to be upwardly disposed and perpendicular to the base plate 11. Rails 10a-10b and 10c-10d are arranged so as to be physically separated by a uniform gap. The spacing between pairs of rails 10a-10b, 10c-10d enables T-shape guides 23a-23d to slide along the rails 10a-10d. The end plate 12 of sheet metal construction is welded or fastened to the end of rails 10a-10d at the upper end 34, as described in FIG. 3. The stiffener 13 of sheet metal construction is welded to the frontmost rails 10b-10c or backmost rails 10a-10d so as to minimize flexure of the base unit 2 during operation. Optional brackets 32 are welded or fastened to the base plate 12 to further stiffen the base unit 2, as shown in FIG. 4.

Referring again to FIG. 2, the support unit 3 is comprised of a pair of separately disposed and parallel vertical support elements 4a-4b fastened to a pair of likewise separately disposed and parallel horizontal support elements 5a-5b. A pair of separately disposed and parallel horizontal rests 19a-19b are secured by fasteners 24a-24b to one end of the vertical support elements 4a-4b, as shown in FIG. 2. Horizontal support elements 5a-5b, vertical support elements 4a-4b, and horizontal rests 19a-19b are fabricated from metal, preferably steel or aluminum, having a solid or hollow cross section. Mounting holes 31a-31d are provided along horizontal support elements 5a-5b so as to accommodate hardware to secure the low-profile television to the support unit 3.

Referring now to FIG. 8, horizontal support elements 5a-5b are secured to vertical support elements 4a-4b via brackets 6a-6d and fasteners 30a-30d so to provide adjustability for various mounting requirements. Brackets 6a-6d have a hollow cross section so as to facilitate sliding movement along the vertical support elements 4a-4b. Brackets 6a-6d are locked in place by tightening a fastener 30a-30d into the vertical support element 4a-4b. Brackets 6a-6d are fixed to the horizontal support elements 5a-5b via flanges 37a-37b. Flanges 37a-37d are welded, via techniques understood in the art, to horizontal support elements 5a-5b and brackets 6a-6d. Brackets 6a-6d and flanges 37a-37d are fabricated from metal, preferably steel or aluminum.

Referring again to FIG. 3, motor 7 and drive screw 8 are shown parallel and equidistant from rails 10a-10b and rails 10c-10d. A representative drive screw 8 is a threaded rod of linear extent fabricated from a metal, preferably steel. Also shown in FIG. 3 is a limit switch 15 having a rod 27 projecting from one end so as to span the distance between base plate 11 and end plate 12. Stops 16a-16b composed of a metal cylinder with set screw are secured to the rod 27 adjacent to base plate 11 and end plate 12.

Referring now to FIG. 4, the motor 7 is secured to the base plate 11 via fasteners 17a-17c. While various motor 7 types are applicable to the present invention, preferred embodiments were reversible and DC powered. One specific example being a 24V motor, model number 403.979 manufactured by Valeo Auto-Electric Wischer und Motoren GmbH (Motors and Actuators Division) with an office at Stuttgarter Strasse 119 D-74321 Bietigheim, Germany.

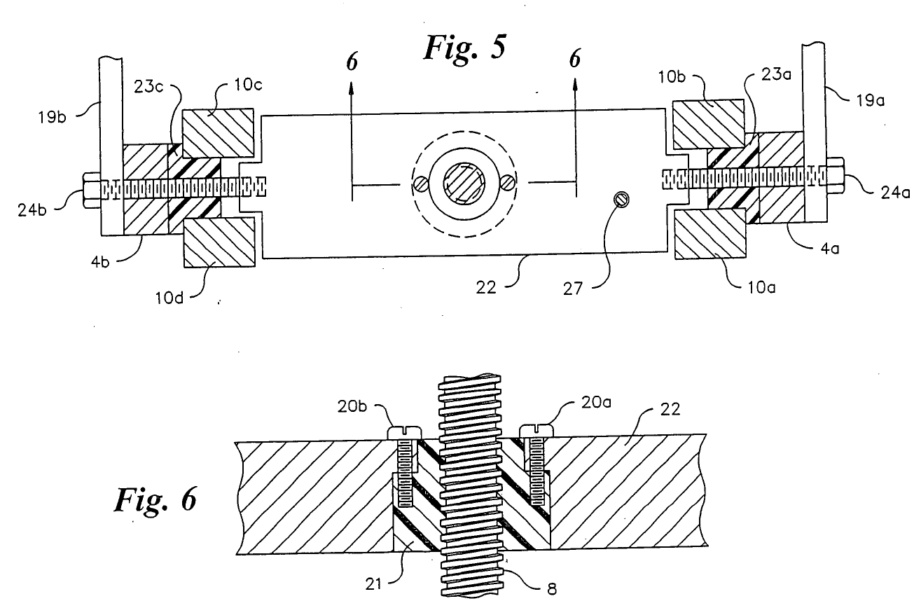

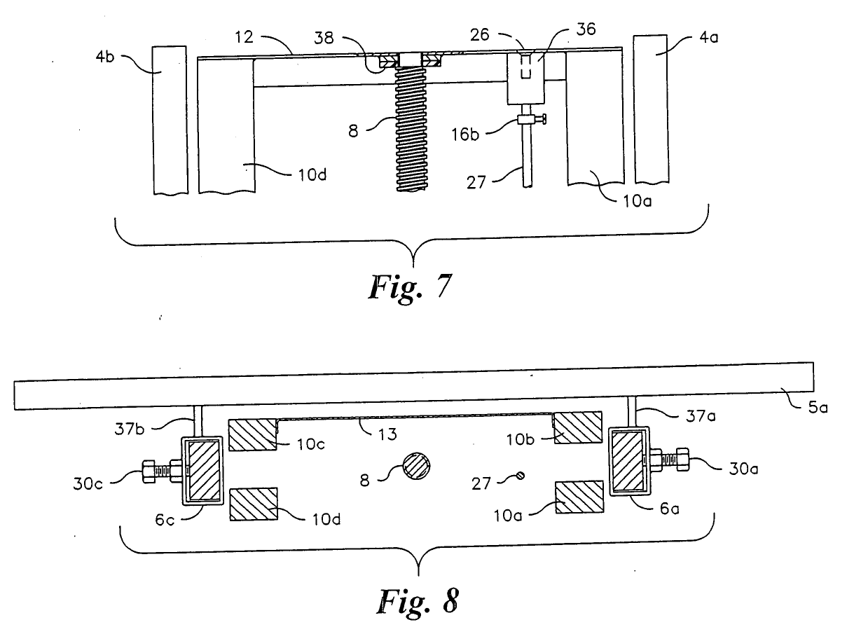

An optional pair of washers 18a-18b is disposed about the base plate 11 for each fastener 17a-17c so as to prevent direct contact between motor 7 and base plate 11. It is preferred that washers 18a-18b be composed of a vibration damping material, examples including but not limited to elastomers, polymers, and lead. A rotating shaft extending from the motor 7 is directly coupled to the drive screw 8 via a coupler 9. The coupler 9 is a metal cylinder having a cavity conforming to the end of both rotating shaft and drive screw 8. The drive screw 8 extends above the coupler 9 passing through the elevator element 14, as shown in FIGS. 5 and 6, and secured to the end plate 12, as shown in FIG. 7.

Referring again to FIG. 4, the limit switch 15 is fastened to the base plate 12 via nuts 33a-33b. The rod 27 extends above the base plate 12 passing through a hole in the elevator plate 22, as shown in FIG. 5, and secured to the end plate 12, as shown in FIG. 7. The rod 27 is freely movable along its length so that contact between elevator plate 22 and stops 16a or 16b move the rod 27 thereby communicating a STOP command to the motor 7 from the limit switch 15. While limit switches 15 are known within the art, preferred embodiments of the present invention were composed of a mechanically activated two position electrical switch.

Referring now to FIG. 5, the elevator element 14 is shown comprised of an elevator plate 22, a pair of T-shaped guides 23a, 23c, and a nut 21. The preferred elevator plate 22 is shaped as shown in FIG. 5 approximately 1-inch thick and composed of a metal member having a cavity centrally located along its planar extent to accommodate the nut 21. One T-shaped guide 23c of comparable thickness to the elevator plate 22 is positioned so that it partially occupies the space between two rails 10c-10d. A second T-shaped guide 23a is positioned so as to contact two rails 10a-10b on the opposite side of the base unit 2. A fastener 24b passes through horizontal rest 19b, vertical support element 4b, and T-shaped guide 23c and thereafter threaded into a cavity within the elevator plate 22 so as to secure components to each other and to the rails 10c-10d. A likewise arrangement secures T-shaped guide 23b, vertical support element 4a, and horizontal rest 19 to the opposite end of the elevator plate 22.

The T-shaped guides 23a, 23c prevent contact between vertical support elements 4a-4b and rails 10a-10d, as well as between elevator plate 22 and rails 10a-10d. Furthermore, the pair of T-shaped guides 23a, 23c constrain travel of the support unit 3 lengthwise along the paired rails 10a-10b and 10c-10d. As such, it is preferred that the T-shaped guides 23a, 23c be comprised of a low-friction material preferably a polymer, one example being polytetrafluorethylene also referred to as PTFE.

Referring now to FIG. 6, the nut 21 extends through the elevator plate 22. The profile of the nut 21 shown in FIG. 6 communicates loading exerted by the drive screw 8 onto the nut 21 into the elevator plate 22 and facilitates attachment of nut 21 to the elevator plate 22 via fasteners 20a, 20b. The nut 21 has a hole through its thickness with a thread pattern matching that of the drive screw 8. It is preferred that the nut 21 be constructed of a material minimizing friction with the drive screw 8. Therefore, preferred embodiments are comprised of a low-friction polymer, preferably PTFE.

Referring now to FIG. 7, the attachment of drive screw 8 and rod 27 to the end plate 12 is shown. The drive screw 8 passes through a hole in the end plate 12 so as to prevent lateral movement of the drive screw 8 but allowing rotational movement. Friction is minimized via a washer 38 composed of a low friction polymer, preferably PTFE, placed between end plate 12 and drive screw 8.

Referring again to FIG. 7, the rod 27 is secured within a cavity along a mounting cap 36 composed of a low-friction polymer and attached to the end plate 12 via a fastener 26. It is desired that the rod 27 be freely movable lengthwise into and out of the mounting cap 36 so as to enable function of limit switch 15.

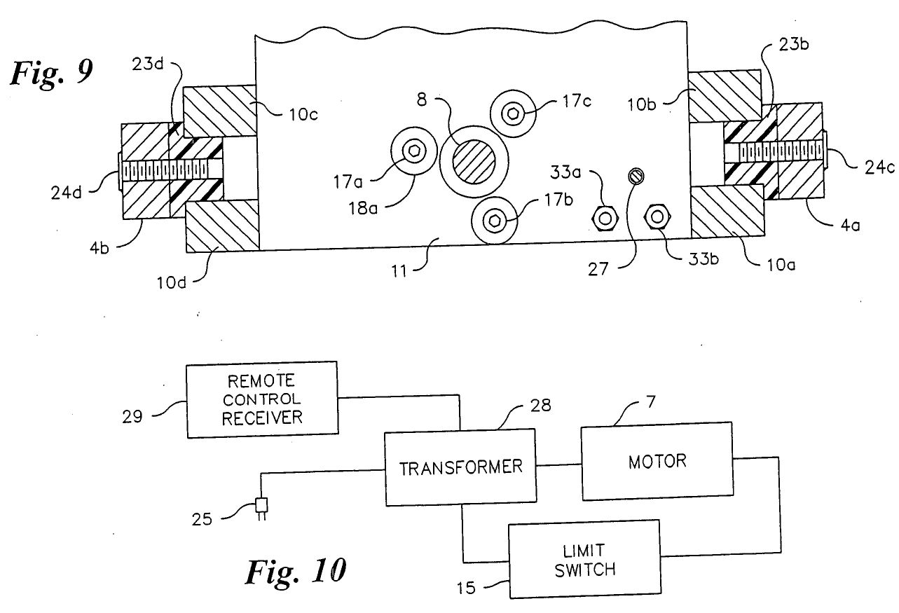

Referring now to FIG. 9, a second pair of T-shaped guides 23b, 23d are shown attached via fasteners 24c, 24d to the vertical support elements 4a-4b. One T-shaped guide 23b is slidably disposed between rails 10a and 10b. A second T-shaped guide 23d is slidably disposed between rails 10c and 10d. The paired arrangement of T-shaped guides 23a-23b and 23c-23d along vertical support elements 4a and 4b, respectively, prevents rotational movement of the support unit 3 transverse to the travel axis of the lift 1.

Referring now to FIG. 10, a block diagram describes the control function of the motor 7 and hence the raising and lowering of the support unit 3. A remote control receiver 29 is electrically connected to a transformer 28 and thereafter to a reversible motor 7. The remote control receiver 29 is an electrical component understood in the art capable of receiving wireless commands as to the activation and deactivation of the motor 7. The transformer 28, also a component understood in the art, receives AC power via a power cord 25 thereafter converting it to DC before communicating it to the motor 7. The limit switch 15 is electrically connected to motor 7 and transformer 28. Contact between elevator plate 22 and stop 16a moves the rod 27 downward thereby mechanically tripping the limit switch 15 and sending an electrical command to the transformer 28 to terminate power to the motor 7. Likewise, contact between elevator plate 22 and stop 16b moves the rod 27 upward thereby mechanically tripping the limit switch 15 and sending an electrical command to the transformer 28 to terminate power to the motor 7. In either event, rotation of the drive screw 8 ceases thereby stopping travel of support unit 3. Additionally, the rotational direction of the motor 7 is reversed for a subsequent reactivation of the motor 7.

In a second embodiment of the invention, there is a lift having a base unit, a support unit, a hanging drive screw assembly, a motor, a transmission and a floating nut assembly. The support unit of the lift is slidably connected over the base unit. Similar to the first embodiment, the support unit may be moved up to an extended position above the base unit for vertically positioning a low-profile display, such as a plasma screen or LCD panel. The support unit may also be moved down to a retracted position when the low-profile display is not being used. In particular, this embodiment of the lift is configured to accommodate the largest and heaviest low-profile display on the market, approximately 50 inches, but may accommodate a smaller low-profile display due to its adjustability of the shelf and horizontal supports, detailed hereinafter.

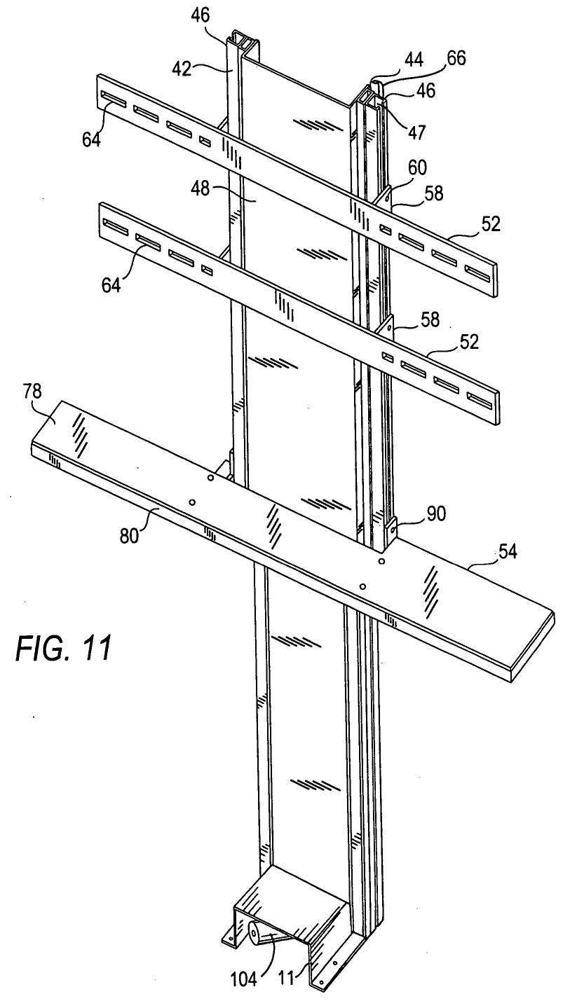

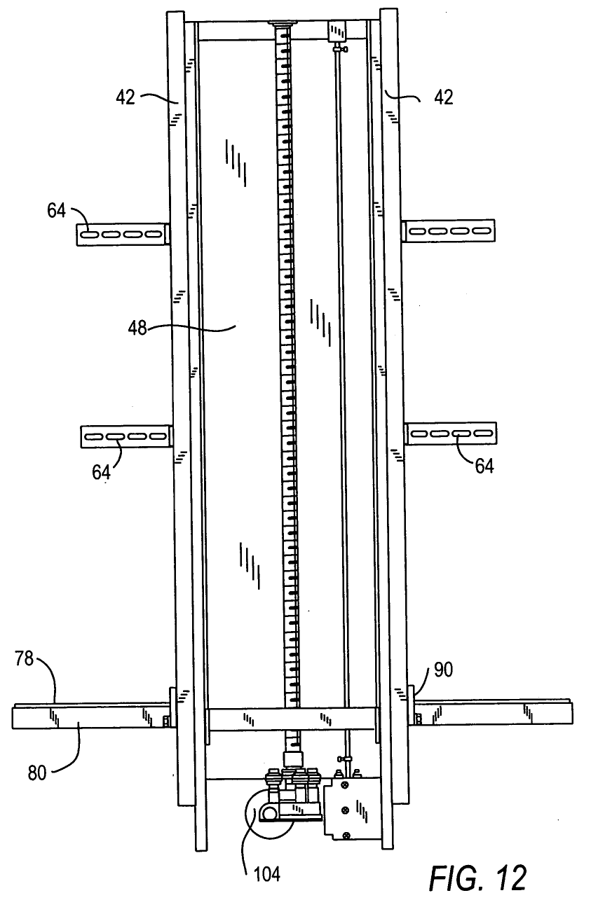

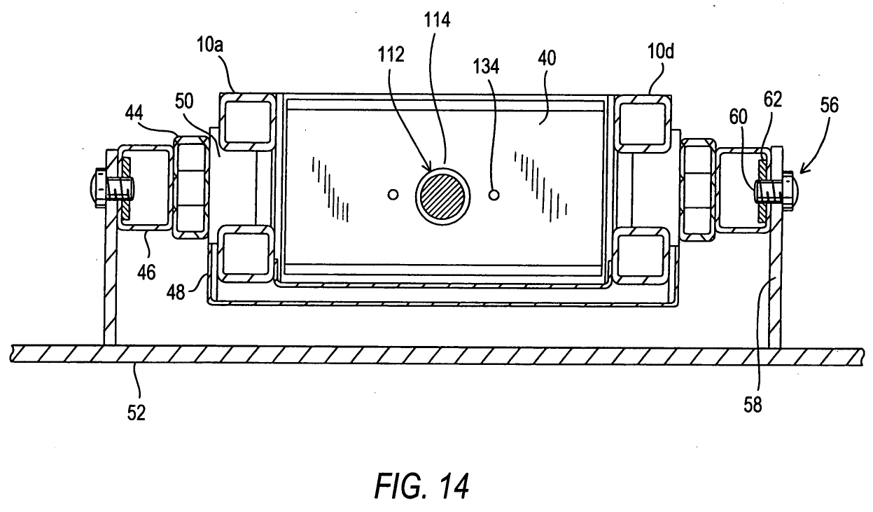

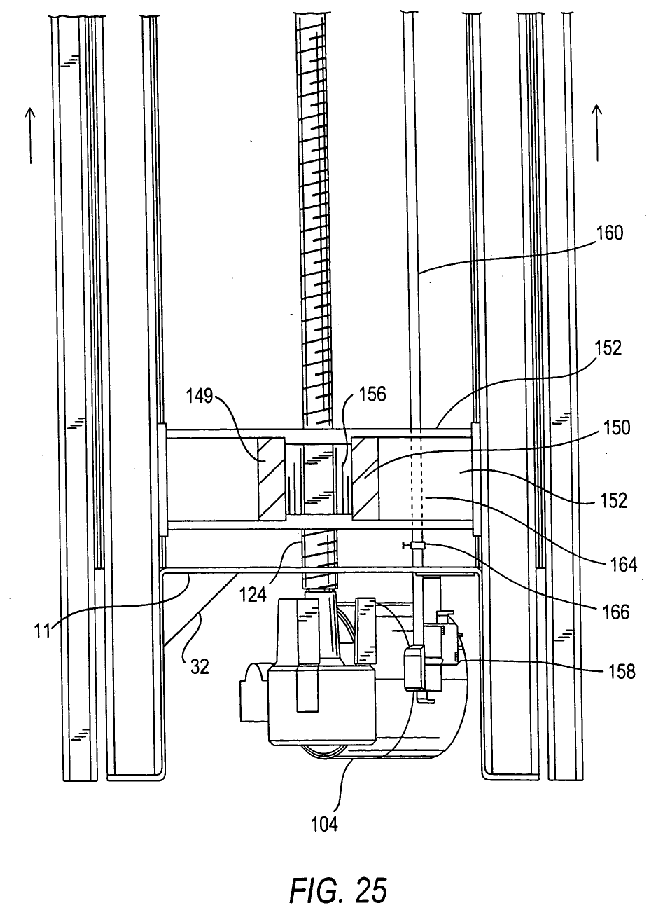

Referring to FIGS. 11 and 14, the base unit 2 is comprised of the base plate 11, the four rails 10a-10d, the stiffener 13 and an end plate 40 modified to be suitable for the second embodiment. Except for the end plate 40, the base unit has similar features as the embodiment of FIGS. 2-5 which is previously described in detail. Thus, the base plate 11 is an inverted U-shaped element fabricated from sheet metal, preferably steel. Rails 10a-10d are either solid or hollow in construction, preferably having a square or rectangular cross section. Rails 10a-10d are arranged in pairs, 10a-10b and 10c-10d, to either side of the U-shaped base plate 11 so that one end of each rail 10a-10d contacts the base plate 11 adjacent to the lower end 35, as described in FIG. 12. Rails 10a-10d are welded or fastened to the base plate 11, via techniques understood in the art, so as to be upwardly disposed and perpendicular to the base plate 11. Rails 10a-10b and 10c-10d are arranged so as to be physically separated by a uniform gap. The spacing between pairs of rails 10a-10b, 10c-10d enables guides, which are T-shaped, used with the support, unit and the floating nut assembly to slide along the rails 10a-10d. An end plate 40 of sheet metal construction, described in detail below, is welded or fastened to the end of rails 10a-10d at the upper end 34. A stiffener 13 of sheet metal construction is welded to the frontmost rails 10b-10c or backmost rails 10a-10d so as to minimize flexure of the base unit 2 during operation. Optional brackets 32 (FIG. 25) are welded or fastened to the base plate 12 to further stiffen the base unit 2.

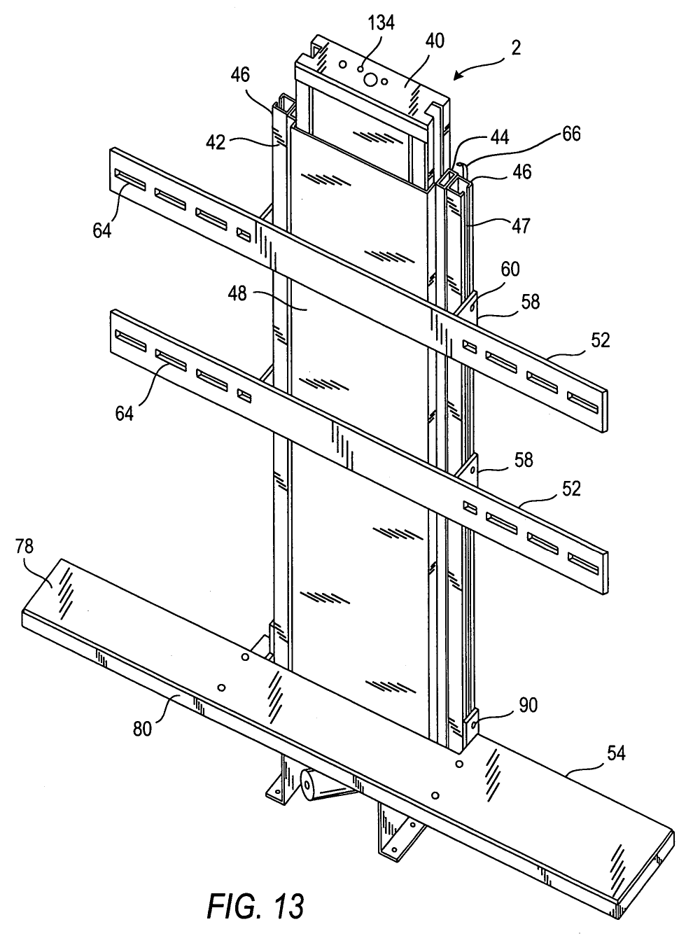

FIGS. 11 and 13 depict a support unit 42 which is comprised of a pair of separately disposed and parallel vertical support elements 44 having attached to each of them a vertical tubular channel 46 having vertically extending slots 47, which are separately disposed and parallel. A supporting structural member 48 comprising a wall of sheet metal construction is welded to the vertical support elements 44 and encloses the frontmost rails 10b, 10c. The supporting structural member provides reinforcement and minimizes flexure of the support unit during operation. The vertical support elements and vertical tubular channels are fabricated from metal, preferably steel or aluminum wherein the vertical support elements may have a solid or hollow cross-section, and the vertical tubular channels, a hollow cross-section. The arrangement of features of the support unit also prevents the lift from tilting forward.

As shown in FIG. 14, the support unit 42 includes a pair of guides 50 which are T-shaped and fastened to each of the vertical support elements 44. The guides 50 are for engagement of the support unit 42 to the base unit and are positioned to partially occupy a space between each pair of rails of the base unit. The guides prevent contact between the base unit and the support unit and should be comprised of a low friction material such as a polymer, for example Teflon or polytetrafluoroethylene (PTFE) to allow for slidable movement.

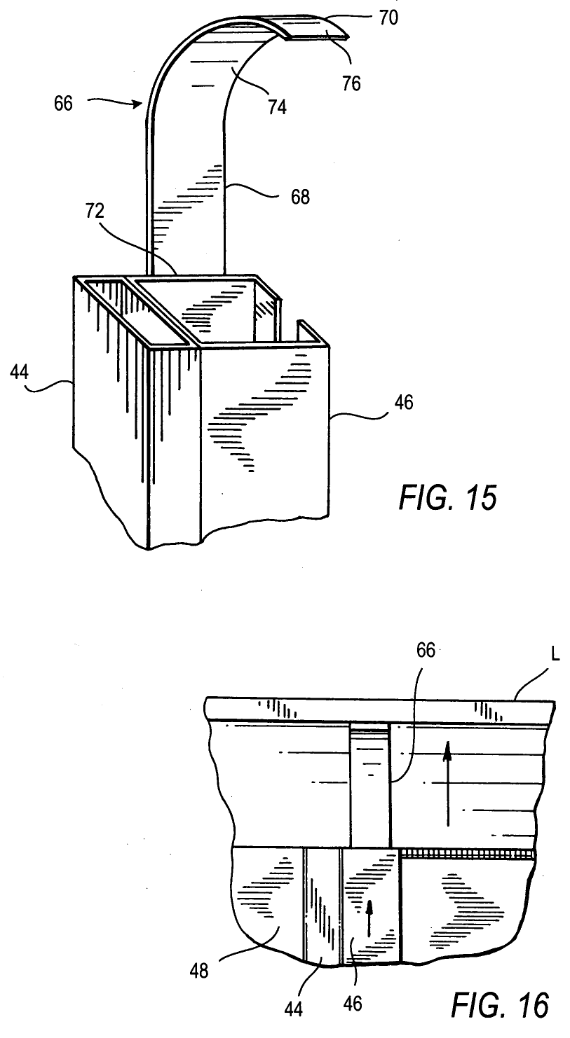

Referring to FIGS. 15 and 16, the support unit 42 may include a support arm 66 called a “cobra arm” which is attached to one of the vertical tubular channels 46 for engaging and raising a lid (L) of a cabinet when the low-profile display is being lifted from the cabinet. The support arm 66 extends up from the tubular channel and curves downward at a top like a cobra head. The support arm 66 includes a vertical portion 68 and a curved portion 70. The vertical portion 68 has a bottom end 72 which is attached to the vertical tubular channel 46, and a top end 74. The curved portion 70 has an inverted U-shape portion 76 which is attached to the top end 74 of the vertical portion. The curved portion may be made of a smooth friction resistant material. The curved portion 70 contacts the lid so that the lid is gradually raised when the motorized lift is raised. The support arm also controllably supports the lid as it closes by gravity when the low-profile display is lowered into the cabinet, and prevents the lid from abruptly falling down during the closing process.

Referring again to FIGS. 11 and 13, fastened to the vertical tubular channels 46 are a pair of separately disposed and parallel adjustable horizontal support elements 52 for mounting the low-profile display and a horizontal shelf 54 for temporary support during installation of the low-profile display and placement in a resting position after installation. The adjustable horizontal support elements 52 are slidably disposed in the vertical tubular channels 46 via fastener assemblies 56 (FIG. 14) so as to facilitate sliding vertical movement along the channels. Each fastener assembly comprises a flange 58, a bolt 60 and a nut 62. The flange 58 has a hole at a far end and extends from the horizontal support so that the hole is adjacent to the channel. The bolt 60 is inserted through the hole and channel and secured via the nut 62. The engagement of the vertical tubular channels and the horizontal support elements allow for vertical sliding movement toward or away from each other depending upon the size of the low-profile display. When the nut and bolt are securely fastened and tightened, the horizontal support elements are locked in place. As shown in FIGS. 11 and 13, the horizontal support elements 52 also have a plurality of elongated mounting holes 64 provided along their length for fastening the low-profile display to the horizontal support elements. The plurality of elongated mounting holes 64 accommodate hardware of different size low-profile displays and provides for horizontal adjustability. The horizontal support elements are fabricated from metal, preferably steel or aluminum.

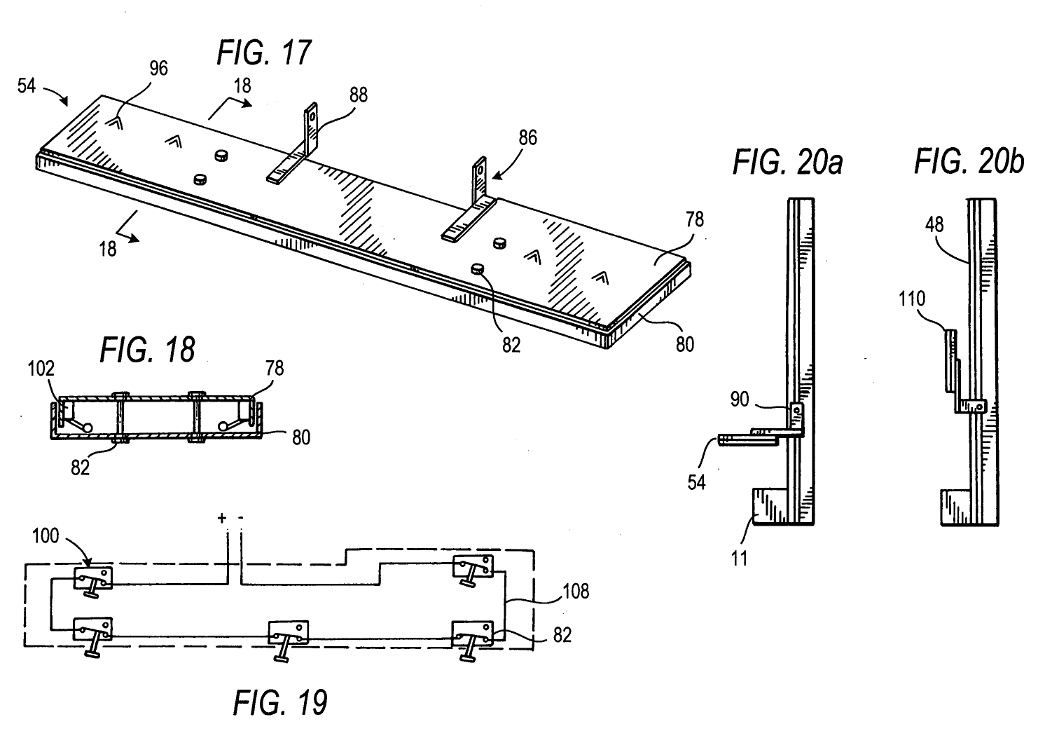

Referring to FIGS. 17-19, the horizontal shelf 54 comprises a top platform 78 parallel to a bottom platform 80 which is loosely mounted in a hanging manner to the top platform 78 via a plurality of connectors 82. The bottom platform 80 includes edges which extend peripherally past edges of the top platform 78 and fold up to meet and surround the edges of the top platform in order to form a shelf having six surfaces. The plurality of connectors 82, preferably four, are threaded and mate with openings in the top platform 78 and the bottom platform 80, and secured by a plurality of nuts.

The position of the horizontal shelf 54 is vertically adjustable and located below the horizontal support elements 52, as shown in FIG. 11. Similar to the adjustable horizontal support elements, the horizontal shelf 54 is slidably disposed in the vertical tubular channels 46 via fastener assemblies 86. Each fastener assembly 86 comprises a flange 88, a bolt 90 (FIG. 20a) and a nut (not shown). The flange 88 has a hole at a far end and extends from the horizontal shelf so that the hole and channel are adjacent to each other. The bolt 90 is inserted through the hole and channel and secured via the nut. The adjustable engagement of the vertical tubular channels and the horizontal shelf allows the horizontal shelf to be moved up to temporarily support the low-profile display in a convenient position while the low-profile display is being fastened to the horizontal support elements.

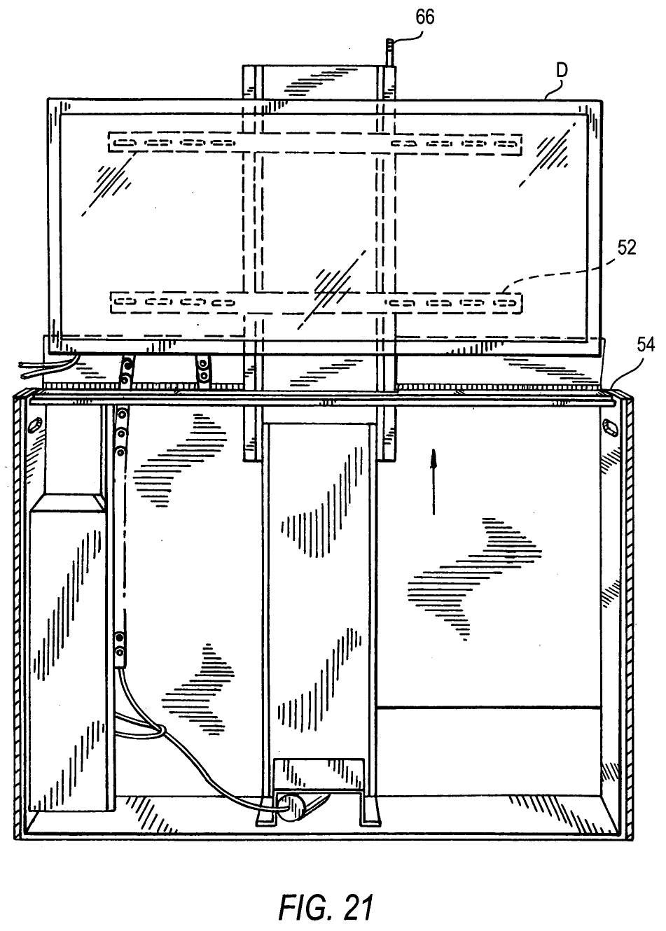

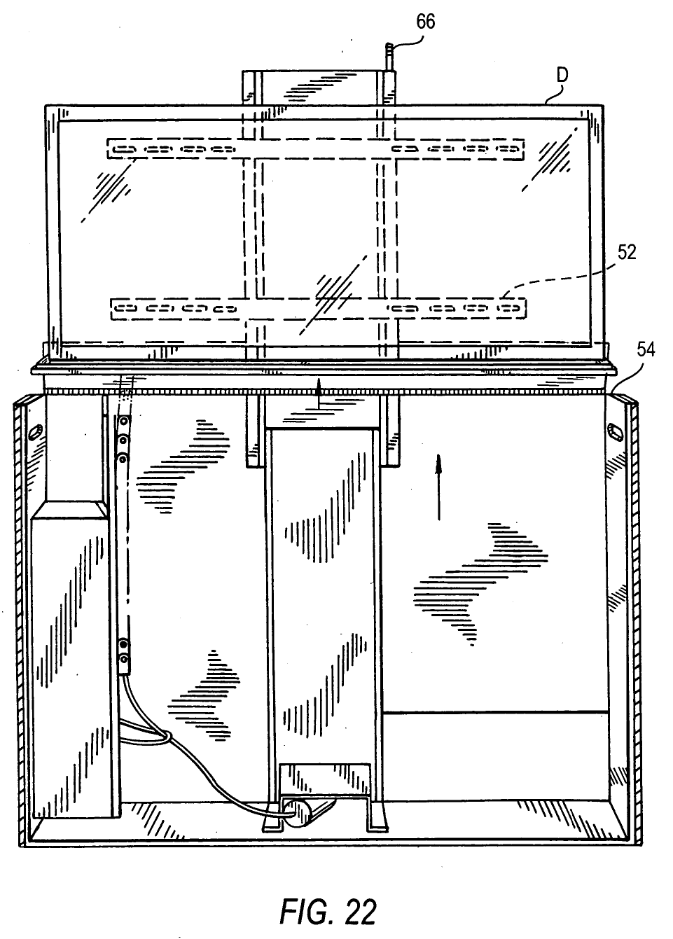

After the low-profile display has been attached to the horizontal support elements 52, the horizontal shelf 54 is moved down so that wires may be secured and the lift may be programmed during installation, as shown by the low-profile display (D) in FIG. 21. When the horizontal shelf is in a descended position, there is ample space to install and program the low-profile display and lift. Once the programming and installation is complete, the wires are placed behind the structural member (FIG. 22) as a safety precaution and are securely out of sight and unaccessible during operation.

Referring to FIG. 17, there are a plurality of latches 96, and a plurality of nooses (not shown) used in conjunction with the latches, for securing the wires from the low profile display and other electronics to the top platform 78 of the horizontal shelf 54. The nooses are placed through the latches 96 and securely around the wires and tightened. As shown in FIG. 22, the horizontal shelf is then moved upward until the shelf is located directly under the low-profile display and bears against a bottom of the low-profile display.

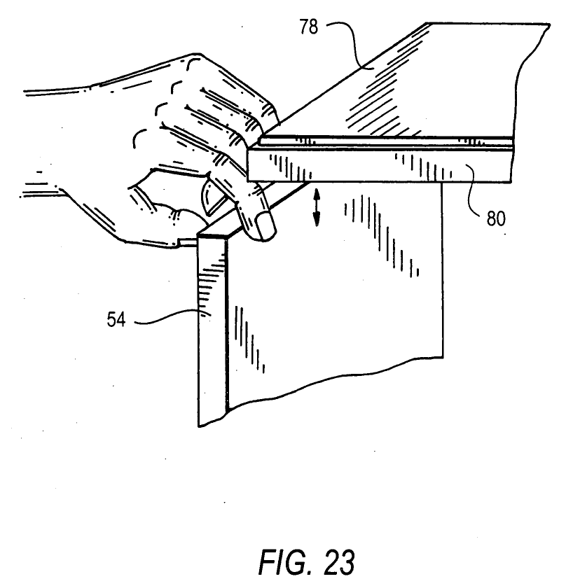

As shown on FIG. 19, the horizontal shelf 54 may also include a safety mechanism 100 comprising a plurality of micro-switches 102 for communicating a stop command to a motor 104 which is reversible. The safety mechanism prevents a user from harming a body part, such as a finger (FIG. 23), when the motorized lift is in use, especially when the horizontal shelf is in a descending motion. The plurality of micro-switches 102 are mounted underneath the top platform 78. Since the bottom platform is loosely mounted, the micro-switches do not touch the bottom platform. The plurality of micro-switches are also electrically connected in a circuit to the motor and a transformer 106. During motion of the horizontal shelf, if the bottom platform contacts anything, such as a finger, the bottom platform 80 is compressed up towards the top platform and presses the micro-switches. Contact between the bottom platform 80 and the micro-switches breaks an electrical circuit 108 and sends an electrical STOP command to the transformer to terminate power to the motor. Movement of the support unit 42 ceases. It is understood that the preferred number of micro-switches used in the present embodiment is five, however any number of micro-switches may be used.

As shown in FIGS. 20a and 20b, the horizontal shelf 54 may be rotated 45 degrees into a vertical folded up position 110 by rotating the horizontal shelf via the fastener assemblies. The nuts and bolts of the fastener assemblies may be loosened such that the flanges are movably rotated and the shelf is adjacent to the supporting structural member 48. Positioning the horizontal shelf 54 in the vertical position provides a compact construction for shipment, therefore minimizing shipping costs.

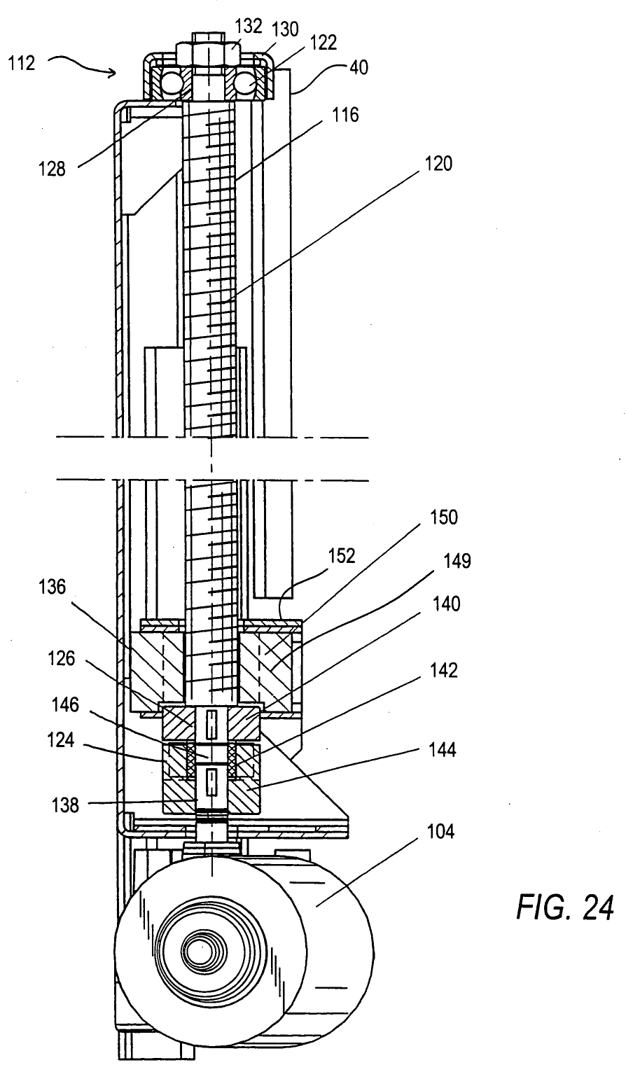

Referring to FIG. 24, the hanging drive screw assembly 112 is shown equidistant from the rails 10a-d (FIG. 12) and passing through an opening 114 in the end plate 40. The hanging drive screw assembly is allowed to loosely hang and is freely movable while suspended from the end plate. The mobility of the hanging configuration accommodates slight lateral movement of the hanging drive screw assembly and removes the load on the transmission and the motor. Friction may be minimized via a washer composed of a low friction polymer, preferably PTFE, placed between the end plate and the hanging drive screw assembly.

The hanging drive screw assembly 112 comprises a drive screw 116 having a threaded rod 120 of linear extent fabricated from metal, preferably steel, and a ball bearing mechanism 122. The threaded rod 120 of the drive screw extends down the length of the base unit and spans the distance between the end plate 40 and a transmission 124. A top end 128 of the threaded rod has a smaller diameter which is inserted through the ball bearing mechanism 122 and the end plate 40. The threaded rod also has a smaller diameter at a bottom end 126 which is coupled to the transmission 124 as described below. The hanging drive screw assembly is freely movable while it is suspended from the end to accommodate slight misalignment during operation.

The ball bearing mechanism may pivot in any plane to accommodate for slight lateral movement and misalignment of the drive screw assembly without binding during operation of the lift. The ball bearing mechanism is supported on the end plate 40 of the base unit. It is understood that various ball bearings may be used with the motorized lift and is preferably one which allows for universal motion. A cover 130 is placed on top of the ball bearing mechanism 122, and the cover 130 and the top end of the threaded rod are secured via a nut 132. The cover prohibits the ball bearing mechanism from moving up during operation. Located on each side of the cover 130, is a securing member 134 (FIG. 14) for securely fastening the drive screw assembly 112 once it has been suspended through the end plate. The support unit 42 may be manually lifted via the hanging drive screw assembly 112 by placing a wrench around the drive screw and moving in a clockwise rotational motion.

To prevent direct contact between the drive screw and the motor, and to eliminate noise, undesired wobbling movement and intermittent binding, in the second embodiment the motor is not directly coupled to the drive screw. As shown in FIGS. 24 and 25, the motor is coupled to the transmission 124 which is coupled to the threaded rod of the drive screw 118. The transmission is located below a floating nut assembly 136 which the drive screw moves through. The drive screw 118 is thereafter coupled to the support unit 42 via an elevator plate 152, which converts screw rotation to linear motion.

The motor 104 is located below the base plate 11 and coupled to the transmission 124 via a motor output shaft 138 located at a top of the motor. It is understood that various motors may be used with the motorized lift. For example, a typical reversible and DC powered motor used is manufactured by Valeo Auto-Electric Wischer und Motoren GmbH as previously disclosed in the first embodiment.

Referring to FIG. 24, the motor output shaft 138 passes through an opening in the base plate 11 and is in direct contact with the transmission 124. The transmission 124, which is cylindrical in shape and hollow, includes a top portion 140, a middle portion 142 and a bottom portion 144, all portions being secured together in a mating relationship. The bottom portion 144 is coupled to the motor output shaft 138 in a mating relationship and may be made of metal. The middle portion 142 is made of a plastic material and also provides insulation from heat dissipating from the power supply and motor. The middle portion prevents heat from traveling up or affecting the operation of the drive screw. The top portion 140 is coupled to the drive screw 116 in a mating relationship and may be made of metal. When the transmission is assembled, there is an open cavity 146 between the output shaft and drive screw. The open cavity and the plastic middle portion prevent transfer of vibrational movement and allows for slight deviations in the axial alignment of the drive screw. The transmission is preferably a Rotex GS 9 type of transmission. However it is understood that other types of transmission appropriate for use with the motorized lift may be used.

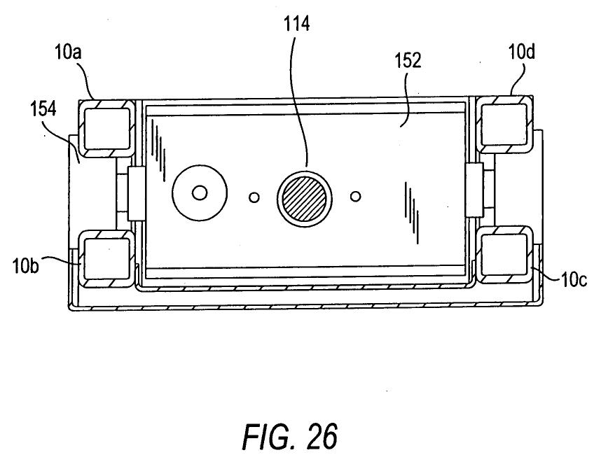

As shown in FIGS. 24-26, the floating nut assembly 136 comprises a floating nut 149 movably mounted in a housing 150 of the elevator plate 152, and a pair of guides 154 which are T-shaped. The elevator 152 has a cavity centrally located along its planar extent to accommodate the housing 150 and the floating nut 149, and may be composed of metal. The guides 154 are positioned to partially occupy the space between rails 10a, 10b of the base unit, and the second guide similarly occupies the space between rails 10c, 10d. The guides 154 are slidably disposed between the rails and prevent direct contact between the elevator plate 152 and the base unit. The floating nut 149 has an internally threaded opening 156 through its thickness. The drive screw is threaded through the floating nut which moves the elevator plate when rotated. The floating nut has the ability to move around in all directions in the housing and “float” when the drive screw is moving through the elevator plate. The floating nut may be constructed of a material which minimizes friction with the drive screw and has shock absorber characteristics, such as a polyamide nut.

Also shown in FIG. 25 is a limit switch 158 having a rod 160 projecting from one end so as to span a distance between the base plate 11 and the end plate 40. The limit switch is fastened to the base plate via nuts (not shown). The rod extends above the base plate passing through a hole 164 in the elevator plate of the floating nut assembly and secured to the end plate 40 as in the first embodiment. Stops 166 composed of a metal cylinder with set screw are secured to the rod adjacent to the base plate 11 and the end plate 40. The elevator plate 152 is freely movable along the length of the rod 160 so that contact between the elevator plate and stops move the rod and communicate a STOP command to the motor from the limit switch. The motor direction is reversed and ready to move in an opposite direction when reactivated. The limit switch in the second embodiment may be a mechanically activated two position electrical switch.

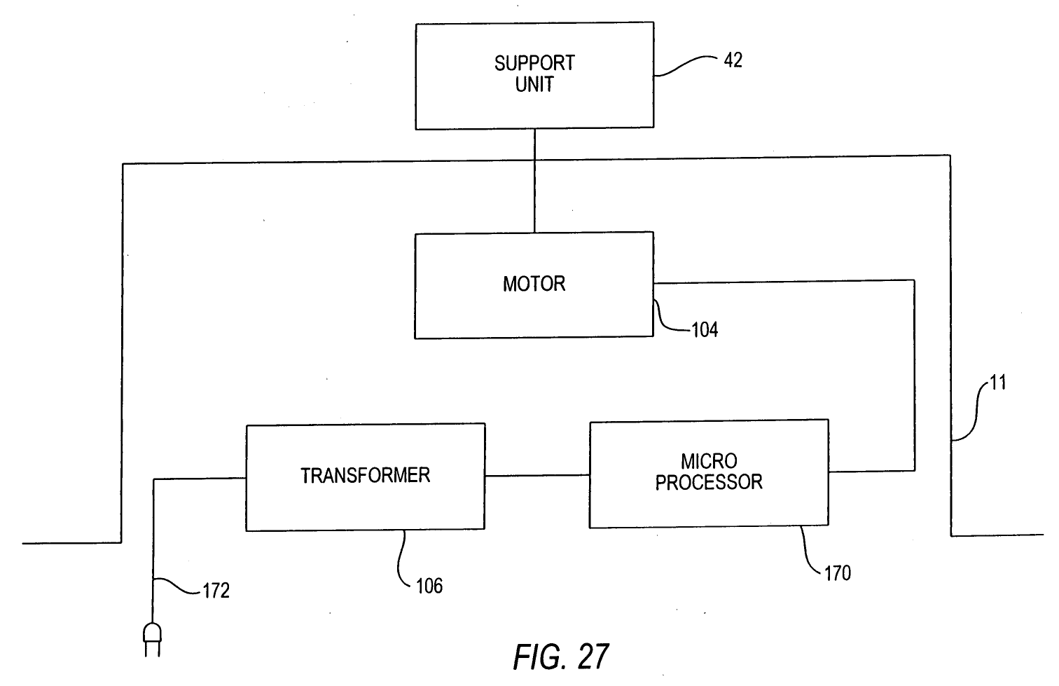

Referring now to FIG. 27, a block diagram illustrates a power supply box 168 enclosing the motor 104, the transformer 106, a microprocessor 170 and an outlet for a power cord 172 for the motorized lift. The power supply box is positioned underneath the base plate 11. The transformer receives AC power via a power cord thereafter converting it to DC before communicating it to the motor. The control function of the motor and hence the raising and lowering of the support unit is similar to that described above for the first embodiment. Housing the electronics in the power supply box allows for easy accessibility when servicing the lift and provides for a compact set up.

The description above indicates that a great degree of flexibility is offered with the motorized lift. The motorized lift device facilitates the uninterrupted and nearly noiseless movement of a low-profile television by eliminating undesirable movement and pressures, and accommodates for any misalignments. The motorized lift also allows for adjustability of many features in order to accommodate various sized low-profile displays. Although the motorized lift has been described in considerable detail with reference to certain preferred versions thereof, other versions are possible. Therefore, the spirit and scope of the appended claims should not be limited to the description of the preferred versions contained herein.

1. A motorized lift device for raising and lowering a low-profile display comprising:
(a) a support unit for mounting the low profile display, the support unit having:
a supporting structural member;
a pair of vertical support elements separately disposed and parallel, the pair of vertical support elements attached to the supporting structural member;
a pair of vertical tubular channels separately disposed and parallel, the pair of vertical tubular channels attached to the pair of vertical support elements;
a pair of horizontal support elements separately disposed and parallel and having a plurality of mounting holes located along ends of the horizontal support elements, the plurality of mounting holes allowing for adjustability during horizontal mounting of the low-profile display; and,
a horizontal shelf located below the pair of horizontal support elements, wherein the pair of adjustable horizontal support elements and the adjustable horizontal shelf are slidably engaged in the pair of vertical tubular channels and adjustable vertically so as to accommodate any size low-profile display;
(b) a base unit for supporting the support unit when telescoped to an extended position and down to a retracted position;
(c) a drive screw provided in a top of the base unit;
(d) a floating nut assembly having a pair of guides for mounting in the base unit; and
(e) a reversible motor coupled to a transmission which is coupled to the drive screw, the drive screw passing through the floating nut assembly having a complimentary thread arrangement which moves the floating nut assembly so that the support unit is telescoped when the drive screw is rotated.

2. The motorized lift device of claim 1, wherein the pair of vertical tubular channels include slots for engaging the pair of horizontal support elements and the horizontal shelf.

3. The motorized lift device of claim 1, wherein the mounting holes are elongated.

4. The motorized lift device of claim 1, wherein the floating nut assembly comprises a nut movably mounted in a housing of an elevator plate.

5. The motorized lift device of claim 4, wherein the nut is a polyamide nut.

6. The motorized lift device of claim 1, further comprising a cobra arm attached to one of the pair of vertical tubular channels.

7. The motorized lift device of claim 1, wherein the pair of horizontal support elements and the horizontal shelf are slidably engaged in the pair of vertical tubular channels via fastener assemblies.

8. The motorized lift device of claim 1, wherein the horizontal shelf includes a plurality of micro-switches.

9. The motorized lift device of claim 1, further comprising a power supply box for enclosing the motor, a transformer, a microprocessor and a power cord.

10. The motorized lift device of claim 1, wherein the horizontal shelf comprises a top platform and a bottom platform, the bottom platform mounted in a hanging manner via a plurality of connectors, and a plurality of micro-switches mounted to the top platform.

11. The motorized lift device of claim 1, wherein the drive screw is hanging and comprises a linear threaded rod and a ball bearing.

12. The motorized lift device of claim 1, wherein the horizontal shelf is rotated 45 degrees to a vertical folded up position.

13. The motorized lift device of claim 1, wherein the floating nut assembly is movable along a rod having stops and configured to communicate a stop command via a limit switch to the motor.

14. An adjustable support unit in a motorized lift device for raising and lowering a low-profile display comprising:
a supporting structural member;
a pair of vertical support elements separately disposed and parallel, the pair of vertical support elements attached to the supporting structural member;
a pair of vertical tubular channels separately disposed and parallel, the pair of vertical tubular channels attached to the pair of vertical support elements;
a pair of horizontal support elements separately disposed and parallel and having a plurality of mounting holes located along ends of the horizontal support elements, the plurality of mounting holes allowing for adjustability during horizontal mounting of the low-profile display; and,
a horizontal shelf located below the pair of horizontal support elements, wherein the pair of adjustable horizontal support elements and the adjustable horizontal shelf are slidably engaged in the pair of vertical tubular channels and adjustable vertically so as to accommodate any size low-profile display.

15. The motorized lift device of claim 14, wherein the mounting holes are elongated.

16. The motorized lift device of claim 14, wherein the pair of vertical tubular channels include slots for engaging the pair of horizontal support elements and the horizontal shelf.

17. The adjustable support unit of claim 14, further comprising a cobra arm attached to one of the pair vertical tubular channels.

18. The adjustable support unit of claim 14, wherein the pair of horizontal support elements and the horizontal shelf are slidably engaged in the pair of vertical tubular channels via fastener assemblies.

19. The adjustable support unit of claim 14, wherein the horizontal shelf includes a plurality of micro-switches.

20. The adjustable support unit of claim 14, further comprising:
a base unit for supporting the adjustable support unit when telescoped to an extended position and down to a retracted position;
a drive screw provided in a top of the base unit;
a floating nut assembly having a pair of guides for mounting in the base unit; and
a reversible motor coupled to a transmission which is coupled to the drive screw, the drive screw passing through the floating nut assembly having a complimentary thread arrangement which moves the floating nut assembly so that the adjustable support unit is telescoped when the drive screw is rotated.

21. The adjustable support unit of claim 20, wherein the drive screw is hanging and comprises a threaded rod and a ball bearing.

22. The adjustable support unit of claim 14, further comprising a power supply box for enclosing the motor, a transformer, a microprocessor and a power cord.

23. A motorized lift device for raising and lowering a low-profile display comprising:
(a) a support unit having a horizontal shelf for mounting the low profile display;
(b) a base unit for supporting the support unit when telescoped to an extended position and down to a retracted position;
(c) a drive screw provided in a top of the base unit;
(d) a floating nut assembly having a pair of guides for mounting in the base unit;
(e) a reversible motor coupled to a transmission which is coupled to the drive screw, the drive screw passing through the floating nut assembly having a complimentary thread arrangement which moves the floating nut assembly so that the support unit is telescoped when the drive screw is rotated; and,
(f) a plurality of micro-switches enclosed in the horizontal shelf for communicating a stop command to the reversible motor.

24. The motorized lift device of claim 23, wherein the horizontal shelf comprises a top platform and a bottom platform, the bottom platform mounted in a hanging manner via a plurality of connectors, and a plurality of micro-switches mounted to the top platform.

25. The motorized lift device of claim 23, wherein the drive screw is hanging and comprises a threaded rod and a ball bearing.

26. The motorized lift device of claim 23, wherein the horizontal shelf is rotated 45 degrees to a vertical folded up position.

27. The motorized lift device of claim 23, wherein the support unit further comprises:
a supporting structural member;
a pair of vertical support elements separately disposed and parallel, the pair of vertical support elements attached to the supporting structural member;
a pair of vertical tubular channels separately disposed and parallel, the pair of vertical tubular channels attached to the pair of vertical support elements; and
a pair of horizontal support elements separately disposed and parallel, and configured above the horizontal shelf; the pair of adjustable horizontal support elements and the adjustable horizontal shelf are slidably engaged in the pair of vertical tubular channels and adjustable vertically so as to accommodate any size low-profile display.

28. The motorized lift device of claim 27, wherein the pair of adjustable horizontal support elements include a plurality of mounting holes located along ends of the horizontal support elements, the plurality of mounting holes allowing for adjustability during horizontal mounting of the low-profile display.

29. The motorized lift device of claim 28, wherein the mounting holes are elongated.

30. The motorized lift device of claim 23, wherein the floating nut assembly comprises a nut movably mounted in a housing of an elevator plate.

31. A motorized lift device for raising and lowering a low-profile display comprising:
(a) a support unit for mounting the low profile display;
(b) a base unit for supporting the support unit when telescoped to an extended position and down to a retracted position;
(c) a drive screw assembly hanging and provided in a top of the base unit, the drive screw assembly having a drive screw and ball bearings, the ball bearings allowing for lateral movement during rotational movement of the drive screw;
(d) a floating nut assembly having a pair of guides for mounting in the base unit; and
(e) a reversible motor coupled to a transmission which is coupled to the drive screw assembly, the drive screw assembly passing through the floating nut assembly having a complimentary thread arrangement, which moves the floating nut assembly so that the support unit is telescoped when the drive screw is rotated such that no load is on the motorized motor.

32. The motorized lift device of claim 31, further comprising a cover for preventing the drive screw assembly from moving up from the base unit during operation.

33. The motorized lift device of claim 31, where the support unit comprises: a supporting structural member;
a pair of vertical support elements separately disposed and parallel, the pair of vertical support elements attached to the supporting structural member;
a pair of vertical tubular channels separately disposed and parallel, the pair of vertical tubular channels attached to the pair of vertical support elements;
a pair of horizontal support elements separately disposed and parallel; and,
a horizontal shelf located below the pair of horizontal support elements, wherein the pair of adjustable horizontal support elements and the adjustable horizontal shelf are slidably engaged in the pair of vertical tubular channels and adjustable vertically so as to accommodate any size low-profile display.

34. The motorized lift device of claim 33, wherein the pair of adjustable horizontal support elements include a plurality of mounting holes located along ends of the horizontal support elements, the plurality of mounting holes allowing for adjustability during horizontal mounting of the low-profile display.

35. The motorized lift device of claim 34, wherein the mounting holes are elongated.

36. A support arm, comprising:
a vertical portion having a top end and a bottom end; and
an inverted U-shaped portion attached to a top end of the vertical portion.

37. The support arm of claim 36, wherein the vertical portion and the inverted U-shaped portion are made of a friction resistant material.

38. A support arm for raising and lowering a lid of cabinet housing a motorized lift device for a low-profile display, comprising:
a vertical portion having a top end and a bottom end, the bottom end for attaching to the motorized lift device; and
an inverted U-shaped portion attached to a top end of the vertical portion, the inverted U-shaped portion contacting the lid so that the lid is gradually raised and lowered during operation of the motorized lift device.

39. The support arm of claim 38, wherein the vertical portion and the inverted U-shaped portion are made of a friction resistant material.

40. A motorized lift device, comprising:
(a) a support unit;
(b) a base unit for supporting the support unit when telescoped to an extended position and down to a retracted position;
(c) a drive screw provided in a top of the base unit;
(d) a floating nut assembly mounted within the base unit; and
(e) a reversible motor coupled to a transmission which is coupled to the drive screw, the drive screw passing through and moving the floating nut assembly so that the support unit is telescoped when the drive screw is rotated.

41. The motorized lift device of claim 40, wherein the support unit comprises:
a supporting structural member;
a pair of vertical support elements separately disposed and parallel, the pair of vertical support elements attached to the supporting structural member;
a pair of vertical tubular channels separately disposed and parallel, the pair of vertical tubular channels attached to the pair of vertical support elements;
a pair of horizontal support elements separately disposed and parallel and having a plurality of mounting holes located along ends of the horizontal support elements, the plurality of mounting holes allowing for adjustability during horizontal mounting of the low-profile display; and,
a horizontal shelf located below the pair of horizontal support elements, wherein the pair of adjustable horizontal support elements and the adjustable horizontal shelf are slidably engaged in the pair of vertical tubular channels and adjustable vertically.

42. The motorized lift device of claim 40, further comprising a cobra arm attached to one of the pair of vertical tubular channels.

43. The motorized lift device of claim 41, wherein the pair of horizontal support elements and the horizontal shelf are slidably engaged in the pair of vertical tubular channels via fastener assemblies.

44. The motorized lift device of claim 41, wherein the mounting holes are elongated.

45. The motorized lift device of claim 41, wherein the horizontal shelf includes a plurality of micro-switches.

46. The motorized lift device of claim 41, wherein the horizontal shelf comprises a top platform and a bottom platform, the bottom platform mounted in a hanging manner via a plurality of connectors, and a plurality of micro-switches mounted to the top platform.

47. The motorized lift device of claim 40, further comprising a power supply box for enclosing the motor, a transformer, a microprocessor and a power cord.

48. The motorized lift device of claim 40, wherein the drive screw is hanging and comprises a threaded rod and a ball bearing.

49. The motorized lift device of claim 41, wherein the horizontal shelf is rotated 45 degrees to a vertical folded up position.

50. The motorized lift device of claim 40, further comprising a cover for preventing the drive screw assembly from moving up from the base unit during operation.

51. The motorized lift device of claim 40, wherein the floating nut assembly comprises a nut movably mounted in a housing of an elevator plate and includes a pair of guides for mounting in the base unit.

52. The motorized lift device of claim 40, wherein the base unit comprises a first pair of separately disposed and parallel rails, a second pair of separately disposed and parallel rails, a base plate, an end plate and a stiffener

53. The motorized lift device of claim 40, further comprising a base plate fixed to the first pair of separately disposed and parallel rails and the second pair of separately disposed and parallel rails in a perpendicular fashion adjacent to a lower end of the base unit, an end plate is fixed to the first pair of separately disposed and parallel rails and the second pair of separately disposed and parallel rails in a perpendicular fashion at an upper end of the base unit, and a stiffener is fixed to and between the first pair of separately disposed and parallel rails and the second pair of separately disposed and parallel rails so as to minimize flexure within the base unit during operation.

54. The motorized lift device of claim 40, wherein the floating nut assembly is movable along a rod having stops located near the base plate and the end plate and configured to communicate a stop command via a limit switch to the motor.

55. The motorized lift device of claim 41, wherein the pair of vertical tubular channels include slots for engaging the pair of horizontal support elements and the horizontal shelf.
